(19) United States
(12) Patent Application Publication
(10) Pub. No.: US 2004/0015364 A1
(43) Pub. Date: Jan. 22, 2004

(54) Electrical appliance, in particular, a ventilator hood

(76) Inventor: Robert Sulc, Dietzenbach (DE)

Correspondence Address: LERNER AND GREENBERG, P.A., POST OFFICE BOX 2480, HOLLYWOOD, FL, 33022-2480, US

(21) Appl. No.: 10/375,530

(22) Filed: Feb. 27, 2003

(30) Foreign Application Priority Data
Feb. 27, 2002 (DE) 102 08 468.8

(51) Int. Cl. G10L 11/00

(52) U.S. Cl. 704/275

(57) ABSTRACT

A ventilator hood includes a voice operating unit with a microphone. A motion detector detects the position of an operator and an output signal, generated by the microphone, based upon a distance, picked up by the motion detector, of the operator from the household appliance. This signal is amplified in accordance with the distance.

### BACKGROUND OF THE INVENTION

### FIELD OF THE INVENTION

The present invention relates to an electrical appliance, in particular, a ventilator hood, with a voice operating unit having a microphone and a voice recognition unit disposed downstream of the microphone.

International application WO 01/59763 A1 discloses an electrical appliance with a voice input unit. Connected downstream of the voice input unit is a voice processing unit that uses spoken input commands to derive control signals for controlling functions of the household appliance. An operational status detection unit is provided that detects the operational status of the household appliance or other noise sources, and reports to the voice processing unit. The voice processing unit undertakes an interference noise correction only if a noise source is switched on. The known method for voice input with correction of interference signals is characterized in that the operational status of at least one noise source that interferes with the voice input is interrogated during the voice input for controlling an appliance, and in that the voice processing unit undertakes an interference noise correction only if a noise source is switched on. Thus, if a voice signal is submitted to the voice processing unit for recognition, an attempt is not made in each case to undertake an interference noise correction. This leads to an improvement in the voice recognition in all cases in which the voice signal is not loaded at all by interference noises. This is because the quality of the voice signal is reduced by the effort to remove nonexistent interference noise from the voice signal, or to take correcting account of it.

### SUMMARY OF THE INVENTION

It is, accordingly, an object of the invention to provide an electrical appliance, in particular, a ventilator hood, that overcomes the hereinafore-mentioned disadvantages of the heretofore-known devices of this general type and that improves the reception of voice signals in the household field based upon other data.

With the foregoing and other objects in view, there is provided, in accordance with the invention, an electrical household appliance, including a voice operating unit having a microphone for receiving voice signals and transmitting an output signal and a voice recognition unit disposed downstream of the microphone in an output signal flow direction, and a motion detector connected to the voice operating unit and detecting at least one of a position and a distance of an operator of the appliance, the voice operating unit amplifying the output signal generated by the microphone based upon at least one of the position and the distance of the operator from the appliance picked up by the motion detector.

With the objects of the invention in view, there is also provided a ventilator hood, including a voice operating unit having a microphone for receiving voice signals and transmitting an output signal and a voice recognition unit disposed downstream of the microphone in an output signal flow direction, and a motion detector connected to the voice operating unit and detecting at least one of a position and a distance of an operator of the hood, the voice operating unit amplifying the output signal generated by the microphone based upon at least one of the position and the distance of the operator from the hood picked up by the motion detector.

According to the invention, in the case of an electrical household appliance of the type mentioned at the beginning, a motion detector is present by which the position of an operator can be detected, and an output signal generated by the microphone can be amplified based upon a distance, picked up by the motion detector, of the operator from the household appliance.

By contrast with other household appliances with voice operation, the electrical household appliance according to the invention has the advantage that a speaker is understood even when he speaks from a distance and when his position, the direction of speech, and the volume received at the microphone change. The speaker can move at will in the room, and yet the microphone recognizes the speaker's voice.

The household appliance is particularly suitable when connected to the microphone is a controllable amplifier by which an A/D converter connected downstream of the microphone can be driven.

In accordance with another feature of the invention, the voice recognition unit is connected to the A/D converter downstream of the A/D converter in the output signal flow direction and derives from the voice signals a manipulated variable for the amplifier and the amplifier provides an input signal to the A/D converter and controls a strength of the input signal.

In accordance with an added feature of the invention, it is advantageous to use a voice recognition unit, connected downstream of the A/D converter, in which a manipulated variable for a controllable amplifier is derived from the voice signal, which amplifier can control the strength of the input signal of the A/D converter.

In accordance with an additional feature of the invention, the voice operating unit, preferably, includes an amplifier that can be controlled by signals generated by the motion detector, and can be controlled by the signal strength generated by the voice recognition unit or a control unit of the voice control circuit.

In accordance with a further feature of the invention, the motion detector generates signals and is connected to the amplifier, the voice operating unit has a control unit connected to the amplifier, the control unit generates a control signal with a signal strength, the voice recognition unit is connected to the amplifier and generates a recognition signal with a signal strength, and a control of the amplifier is based upon the signals generated by the motion detector, the signal strength of the control signal, or the signal strength of the recognition signal.

In accordance with yet another feature of the invention, an embodiment is suitable in which the microphone is alignably disposed and is aligned based upon a position, detected by the motion detector, of an operator.

In accordance with yet a further feature of the invention, it has proved to be advantageous to dispose the individual microphones in a line or on a surface. Thus, the microphone can be a linear or planar microphone array.

In accordance with yet an added feature of the invention, a particularly suitable embodiment lies in the microphone being a directional microphone.

In accordance with a concomitant feature of the invention, an ultrasound or an infrared motion detector can be used as motion detector.

Other features that are considered as characteristic for the invention are set forth in the appended claims.

Although the invention is illustrated and described herein as embodied in an electrical appliance, in particular, a ventilator hood, it is, nevertheless, not intended to be limited to the details shown because various modifications and structural changes may be made therein without departing from the spirit of the invention and within the scope and range of equivalents of the claims.

The construction and method of operation of the invention, however, together with additional objects and advantages thereof, will be best understood from the following description of specific embodiments when read in connection with the accompanying drawings.

### BRIEF DESCRIPTION OF THE DRAWINGS

FIG. 1 is a fragmentary, perspective view of a configuration having a ventilator hood and a cooking surface according to the invention;

FIG. 2 is a simplified schematic and block circuit diagram of components of a voice operating unit according to the invention;

FIG. 3 is a diagrammatic illustration of a linear microphone array; and

FIG. 4 is a diagrammatic illustration of a planar microphone array.

### DESCRIPTION OF THE PREFERRED EMBODIMENTS

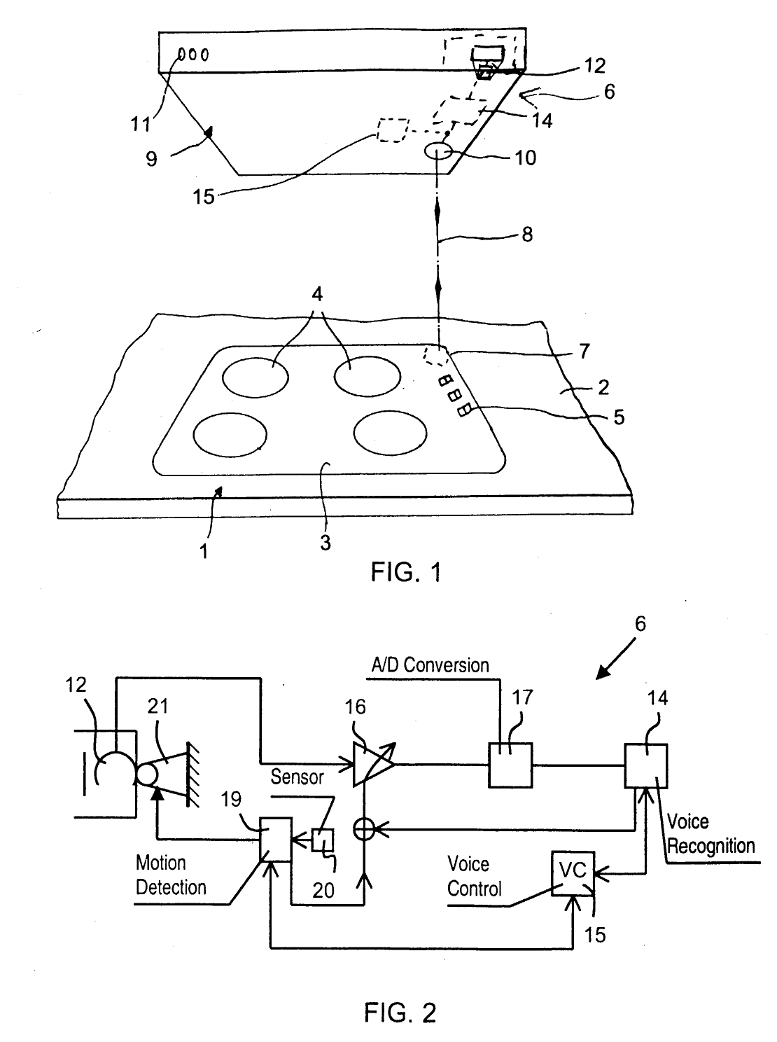

Referring now to the figures of the drawings in detail and first, particularly to FIG. 1 thereof, there is shown a cooking surface 1 mounted in a cutout of an operating plate 2. Various cooking zones 4 are marked on a cooking surface plate 3, which is made from glass ceramic, in particular. Depending on the inputs of an operating and display unit 5 of the cooking surface 1, non-illustrated cooking vessels that are placed on the cooking zones 4 can be heated in a manner known per se by non-illustrated heating elements disposed underneath the cooking surface plate 3, through the control unit. Here, the operating and display unit 5 is present for reasons of comfort and safety. It may be reduced to the minimum that is prescribed for safety equipment, in the case of which the overall configuration also has a voice operating unit 6 as described below.

In the cooking surface 1 there is also a transceiver unit 7, which communicates in a manner known per se through a transmission link 8, operating in a wireless fashion, with a ventilator hood 9 disposed above the cooking surface 1. The transmission link 8 can be implemented, for example, as a radio link in this case. To communicate with the cooking surface 1, the ventilator hood 9 has a transceiver unit 10. The ventilator hood 9, likewise, has operating and display elements 11, through which functions of the ventilator hood 9 are actuated and/or displayed. To permit a voice input, the voice operating unit 6 has a microphone 12. Signals picked up by the microphone 12 are fed to a voice recognition unit 14. The voice recognition unit 14 is connected to a voice control unit 15, which derives a signal for controlling the ventilator hood 9 and/or the cooking surface 1 from the received voice signal. In the latter case, such a signal is transmitted to the cooking surface 1 through the transmission link 8.

The mode of operation of the voice operating unit 6 is explained below with the aid of the block circuit diagram of FIG. 2. The microphone 12 passes received voice signals on to the voice recognition unit 14, which checks whether a competent person attending for the purpose of giving commands is present, or whether the person is a stranger. Stored for such a purpose in a non-illustrated memory associated with the voice recognition unit 14 are speech patterns of those persons who come into consideration as operators for operating the voice operating unit 6. If the voice recognition unit 14 has been able to recognize such a person, the voice signals are passed on to the voice control unit 15, in which the suitable signal is, then, generated to actuate the ventilator hood 9 and/or the cooking surface 1.

Disposed between the microphone 12 and the voice recognition unit 14 is an amplifier 16 that has an adjustable gain and amplifies voice signals picked up by the microphone 12. These signals are, subsequently, fed to an A/D converter 17. The signals are digitized in the A/D converter 17 and passed on to the voice recognition unit 14, in which the voice signals are evaluated.

In addition, the digitized signal of the A/D converter 17 is evaluated with respect to the energy content in the voice recognition unit or in a control unit 15 disposed downstream of the latter. The voice recognition unit 14 derives a further manipulated variable for the controllable amplifier 16 from the signal, such that the energy content of the input signal of the A/D converter 17 remains constant in the case of consideration over the long term, in a fashion largely independent of whether the speaker speaks loudly or softly into the microphone 12. The amplifier 16, therefore, serves the purpose of driving the downstream A/D converter 17 as optionally as possible. When the speaker moves away from the microphone 12, such movement is detected by a motion detector 19, which increases the amplification.

As such, the amplification of the amplifier 16 is increased if the speaker speaks too softly or moves away. The amplification is reduced if the speaker speaks too loudly or approaches. In an alternative embodiment of the invention, the amplifier 16 is controlled by the control unit 15.

The latter is connected to the motion detector 19, which passes the distance that the motion detector 19 has determined between a speaker and the ventilator hood 9 either directly to the amplifier 16 or to the control unit 15, which obtains a control signal for the amplifier 16 from the distance signal and controls the amplifier 16 correspondingly.

To achieve as high as possible a level of reliability of recognition, it is helpful to use, as the microphone 12, a directional microphone that is always aligned in the direction of the speaker. The motion detector 19 includes a suitable sensor 20, which is, for example, an infrared or an ultrasound sensor. The sensor 20 detects the distance and the position of the person speaking and passes a signal corresponding to the distance to the amplifier 16 to adjust the desired, distance-dependent amplification of the voice signals in the amplifier 16.

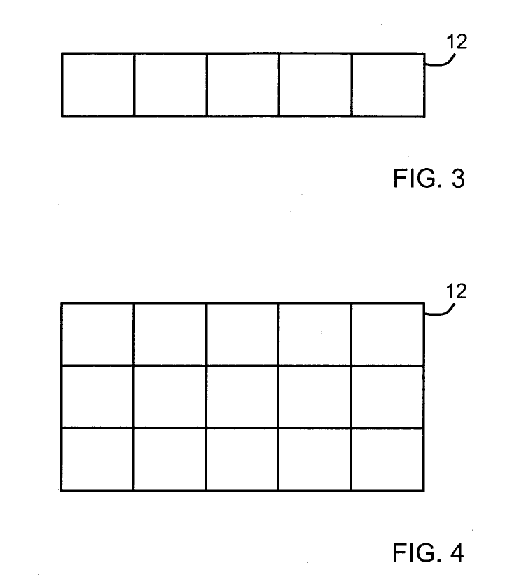

Likewise, the motion detector 19 passes on the angular position detected by the sensor 20 to the microphone 12, configured as a directional microphone. The microphone 12 is, then, aligned in the direction of the speaker by a control device 21. The alignment of the microphone 12 is either performed mechanically, or use is made of a microphone array with downstream analog or digital signal processing. In both cases, the movement position, obtained in the motion detector 19, of the speaker serves the purpose of aligning the microphone 12 onto the speaker. FIGS. 3 and 4 diagrammatically illustrate a linear and a planar microphone array 12, respectively.

In the case of the microphone array, the information relating to the position and the distance of the speaker from the microphone 12 features as a parameter in the voice processing algorithm of the microphone array, which aligns the microphone array computationally onto the speaker. This is performed by the audio signals of the individual microphones of the array being delayed such that the signals from the direction of the detected speaker amplify one another, while the signals from other directions cancel each other out or at least attenuate one another.

I claim:

1. An electrical household appliance, comprising:
a voice operating unit having:
a microphone for receiving voice signals and transmitting an output signal; and
a voice recognition unit disposed downstream of said microphone in an output signal flow direction; and
a motion detector connected to said voice operating unit and detecting at least one of a position and a distance of an operator of the appliance, said voice operating unit amplifying said output signal generated by said microphone based upon at least one of the position and the distance of the operator from the appliance picked up by said motion detector.

2. The household appliance according to claim 1, further comprising:
an A/D converter connected downstream of said microphone in said output signal flow direction; and
a controllable amplifier connected to said microphone and to said A/D converter, said amplifier driving said A/D converter.

3. The household appliance according to claim 2, wherein
said voice recognition unit is connected to said A/D converter downstream of said A/D converter in said output signal flow direction and derives from the voice signals a manipulated variable for said amplifier; and
said amplifier provides an input signal to said A/D converter and controls a strength of said input signal.

4. The household appliance according to claim 1, wherein said microphone is alignable based upon a position of an operator detected by said motion detector.

5. The household appliance according to claim 1, wherein said microphone aligns based upon a position of an operator detected by said motion detector.

6. The household appliance according to claim 1, wherein said microphone is a linear or planar microphone array.

7. The household appliance according to claim 1, wherein said microphone is a directional microphone.

8. The household appliance according to claim 2, wherein:
said motion detector generates signals and is connected to said amplifier;
said voice operating unit has a control unit connected to said amplifier, said control unit generates a control signal with a signal strength;
said voice recognition unit is connected to said amplifier and generates a recognition signal with a signal strength; and
a control of said amplifier is based upon said signals generated by said motion detector, said signal strength of said control signal, or said signal strength of said recognition signal.

9. The household appliance according to claim 1, wherein said motion detector is an ultrasound or infrared sensor.

10. A ventilator hood, comprising:
a voice operating unit having:
a microphone for receiving voice signals and transmitting an output signal; and
a voice recognition unit disposed downstream of said microphone in an output signal flow direction; and
a motion detector connected to said voice operating unit and detecting at least one of a position and a distance of an operator of the hood, said voice operating unit amplifying said output signal generated by said microphone based upon at least one of the position and the distance of the operator from the hood picked up by said motion detector.

11. The hood according to claim 10, further comprising:
an A/D converter connected downstream of said microphone in said output signal flow direction; and
a controllable amplifier connected to said microphone and to said A/D converter, said amplifier driving said A/D converter.

12. The hood according to claim 11, wherein
said voice recognition unit is connected to said A/D converter downstream of said A/D converter in said output signal flow
direction and derives from the voice signals a manipulated variable for said amplifier; and
said amplifier provides an input signal to said A/D converter and controls a strength of said input signal.

13. The hood according to claim 10, wherein said microphone is alignable based upon a position of an operator detected by said motion detector.

14. The hood according to claim 10, wherein said microphone aligns based upon a position of an operator detected by said motion detector.

15. The hood according to claim 10, wherein said microphone is a linear or planar microphone array.

16. The hood according to claim 10, wherein said microphone is a directional microphone.

17. The hood according to claim 11, wherein:
said motion detector generates signals and is connected to said amplifier;
said voice operating unit has a control unit connected to said amplifier, said control unit generates a control signal with a signal strength;
said voice recognition unit is connected to said amplifier and generates a recognition signal with a signal strength; and
a control of said amplifier is based upon said signals generated by said motion detector, said signal strength of said control signal, or said signal strength of said recognition signal.

18. The hood according to claim 10, wherein said motion detector is an ultrasound or infrared sensor.
